(19) United States
(12) Patent Application Publication
(10) Pub. No.: US 2026/0136315 A1
(43) Pub. Date: May 14, 2026

(54) METHOD FOR OBTAINING LOCATION INFORMATION, TERMINAL, AND NETWORK-SIDE DEVICE

(71) Applicant: VIVO MOBILE COMMUNICATION CO., LTD., Dongguan (CN)

(72) Inventors: Huan LI, Dongguan (CN); Xiaobo WU, Dongguan (CN); Xiaowan KE, Dongguan (CN)

(73) Assignee: VIVO MOBILE COMMUNICATION CO., LTD., Dongguan (CN)

(21) Appl. No.: 19/032,116

(22) Filed: Jan. 20, 2025

Related U.S. Application Data
(63) Continuation of application No. PCT/CN2023/105210, filed on Jun. 30, 2023.

(30) Foreign Application Priority Data
Jul. 18, 2022 (CN) 202210843317.6

(51) Int. Cl. H04W 64/00; H04W 4/70

(52) U.S. Cl. CPC H04W 64/00; H04W 4/70

(57) ABSTRACT

Embodiments of this application disclose a method for obtaining location information, a terminal, and a network-side device. The method for obtaining location information includes: obtaining, by a first network element, a request message, where the request message is used for requesting to obtain location information of an Internet of Things device, and the Internet of Things device is a device that obtains energy from an environment; determining, by the first network element, a positioning network element based on the request message; and receiving, by the first network element, positioning information from the positioning network element, where the positioning information is used for determining the location information of the Internet of Things device.

### CROSS-REFERENCE TO RELATED APPLICATIONS

This application is a continuation of International Application No. PCT/CN 2023/105210, filed Jun. 30, 2023, which claims priority to Chinese Patent Application No. 202210843317.6, filed Jul. 18, 2022. The entire contents of each of the above-referenced applications are expressly incorporated herein by reference.

### TECHNICAL FIELD

This application relates to the field of communication technologies, and specifically, to a method for obtaining location information, a terminal, and a network-side device.

### BACKGROUND

A current mobile phone establishes contact with a base station in a communication network, and the communication network may obtain location information of the mobile phone through the base station. An Internet of Things device is a terminal device used in some specific scenarios or specific services, including, for example, a smart home/city, a smart utility, electronic health, and a smart wearable device. Some Internet of Things devices have low operating power consumption, and can support a short communication distance, which is much shorter than a communication distance between a current terminal (such as the mobile phone) and the base station. Therefore, in outdoor or indoor occlusion scenarios, the Internet of Things devices may not be able to come into contact with the base station. In this way, a mobile network cannot obtain location information of the Internet of Things devices.

### SUMMARY

Embodiments of this application provide a method for obtaining location information, a terminal, and a network-side device.

According to a first aspect, a method for obtaining location information is provided, including: obtaining, by a first network element, a request message, where the request message is used for requesting to obtain location information of an Internet of Things device, and the Internet of Things device is a device that obtains energy from an environment; determining, by the first network element, a positioning network element based on the request message; and receiving, by the first network element, positioning information from the positioning network element, where the positioning information is used for determining the location information of the Internet of Things device.

According to a second aspect, a method for obtaining location information is provided, including: receiving, by a positioning network element, a request message from a first network element, where the request message is used for requesting to obtain positioning information of an Internet of Things device, and the Internet of Things device is a device that obtains energy from an environment; assisting, by the positioning network element based on the request message, the first network element in obtaining the positioning information, where the positioning information is used for determining location information of the Internet of Things device; and sending, by the positioning network element, the positioning information to the first network element.

According to a third aspect, a method for obtaining location information is provided, including: sending, by a second terminal, a request message to a first network element, where the request message is used for requesting to obtain location information of an Internet of Things device, and the Internet of Things device is a device that obtains energy from an environment; and receiving, by the second terminal, the location information of the Internet of Things device, where the location information of the Internet of Things device is from the first network element.

According to a fourth aspect, a method for obtaining location information is provided, including: receiving, by a second network element, a request message from a second terminal, where the request message is used for requesting to obtain location information of an Internet of Things device, and the Internet of Things device is a device that obtains energy from an environment; obtaining, by the second network element, the location information of the Internet of Things device; and sending, by the second network element, the location information to the second terminal.

According to a fifth aspect, an apparatus for obtaining location information is provided, including: a first obtaining module, configured to obtain a request message, where the request message is used for requesting to obtain location information of an Internet of Things device, and the Internet of Things device is a device that obtains energy from an environment; a determining module, configured to determine a positioning network element based on the request message; and a first receiving module, configured to receive positioning information from the positioning network element, where the positioning information is used for determining the location information of the Internet of Things device.

According to a sixth aspect, an apparatus for obtaining location information is provided, including: a second receiving module, configured to receive a request message from a first network element, where the request message is used for requesting to obtain positioning information of an Internet of Things device, and the Internet of Things device is a device that obtains energy from an environment; a second obtaining module, configured to assist, based on the request message, the first network element in obtaining the positioning information, where the positioning information is used for determining location information of the Internet of Things device; and a second sending module, configured to send the positioning information to the first network element.

According to a seventh aspect, an apparatus for obtaining location information is provided, including: a third sending module, configured to send a request message to a first network element, where the request message is used for requesting to obtain location information of an Internet of Things device, and the Internet of Things device is a device that obtains energy from an environment; and a third receiving module, configured to receive the location information of the Internet of Things device, where the location information of the Internet of Things device is from the first network element.

According to an eighth aspect, an apparatus for obtaining location information is provided, including: a fourth receiving module, configured to receive a request message from a second terminal, where the request message is used for requesting to obtain location information of an Internet of Things device, and the Internet of Things device is a device that obtains energy from an environment; a fourth obtaining module, configured to obtain the location information of the Internet of Things device; and a fourth sending module, configured to send the location information to the second terminal.

According to a ninth aspect, a terminal is provided, including a processor and a memory, where the memory stores a program or instructions runnable on the processor, and the program or the instructions, when executed by the processor, implement steps of the method according to the second aspect or the third aspect.

According to a tenth aspect, a terminal is provided, including a processor and a communication interface, where the processor or the communication interface is configured to implement steps of the method according to the second aspect or the third aspect.

According to an eleventh aspect, a network-side device is provided, including a processor and a memory, where the memory stores a program or instructions runnable on the processor, and the program or the instructions, when executed by the processor, implement steps of the method according to the first aspect, the second aspect, or the fourth aspect.

According to a twelfth aspect, a network-side device is provided, including a processor and a communication interface, where the processor or the communication interface is configured to implement steps of the method according to the first aspect, the second aspect, or the fourth aspect.

According to a thirteenth aspect, a system for obtaining location information is provided, including a terminal and a network-side device, where the terminal may be configured to perform steps of the method according to the second aspect or the third aspect, and the network-side device may be configured to perform steps of the method according to the first aspect, the second aspect, or the fourth aspect.

According to a fourteenth aspect, a readable storage medium is provided, storing a program or instructions, where the program or the instructions, when executed by a processor, implement steps of the method according to any one of the first aspect to the fourth aspect.

According to a fifteenth aspect, a chip is provided, including a processor and a communication interface, where the communication interface is coupled to the processor, and the processor is configured to run a program or instructions, to implement steps of the method according to any one of the first aspect to the fourth aspect.

According to a sixteenth aspect, a computer program/program product is provided. The computer program/program product is stored in a storage medium. The computer program/program product is executed by at least one processor to implement steps of the method according to any one of the first aspect to the fourth aspect.

In the embodiments of this application, after a request message is obtained, a first network element may determine a positioning network element based on the request message. The positioning network element may obtain positioning information of an Internet of Things device. The first network element receives the positioning information from the positioning network element. In the embodiments of this application, the positioning network element assists in obtaining location information of the Internet of Things device, so that when the Internet of Things device is far away from or blocked from a base station of a mobile network, the location information of the Internet of Things device can still be obtained through the positioning network element, thereby implementing positioning of the Internet of Things device.

### BRIEF DESCRIPTION OF THE DRAWINGS

FIG. 1 is a schematic diagram of a wireless communication system according to an embodiment of this application;

FIG. 2 is a schematic flowchart of a method for obtaining location information according to an embodiment of this application;

FIG. 3 is a schematic flowchart of a method for obtaining location information according to an embodiment of this application;

FIG. 4 is a schematic flowchart of a method for obtaining location information according to an embodiment of this application;

FIG. 5 is a schematic flowchart of a method for obtaining location information according to an embodiment of this application;

FIG. 6 is a schematic flowchart of a method for obtaining location information according to an embodiment of this application;

FIG. 7 is a schematic flowchart of a method for obtaining location information according to an embodiment of this application;

FIG. 8 is a schematic structural diagram of an apparatus for obtaining location information according to an embodiment of this application;

FIG. 9 is a schematic structural diagram of an apparatus for obtaining location information according to an embodiment of this application;

FIG. 10 is a schematic structural diagram of an apparatus for obtaining location information according to an embodiment of this application;

FIG. 11 is a schematic structural diagram of an apparatus for obtaining location information according to an embodiment of this application;

FIG. 12 is a schematic structural diagram of a communication device according to an embodiment of this application;

FIG. 13 is a schematic structural diagram of a terminal according to an embodiment of this application;

FIG. 14 is a schematic structural diagram of a network-side device according to an embodiment of this application; and

FIG. 15 is a schematic structural diagram of a network-side device according to an embodiment of this application.

### DETAILED DESCRIPTION

The following clearly describes the technical solutions in the embodiments of this application with reference to the accompanying drawings in the embodiments of this application. Apparently, the described embodiments are some embodiments of this application rather than all of the embodiments. All other embodiments obtained by a person of ordinary skill in the art based on the embodiments of this application fall within the protection scope of this application.

The specification and claims of this application, and terms “first” and “second” are used to distinguish similar objects, but are unnecessarily used to describe a specific sequence or order. It should be understood that the terms in such a way are interchangeable in proper circumstances, so that the embodiments of this application can be implemented in other orders than the order illustrated or described herein. Objects distinguished by “first” and “second” are usually one type, and the quantity of objects is not limited. For example, the first object may be one or more than one. In addition, in the specification and the claims, “and/or” means at least one of the connected objects, and the character “/” generally indicates an “or” relationship between the associated objects.

It should be noted that, the technologies described in the embodiments of this application are not limited to a Long Term Evolution (LTE) system or an LTE-Advanced (LTE-A) system, and can also be used in other wireless communication systems, such as, Code Division Multiple Access (CDMA), Time Division Multiple Access (TDMA), Frequency Division Multiple Access (FDMA), Orthogonal Frequency Division Multiple Access (OFDMA), and Single-carrier Frequency Division Multiple Access (SC-FDMA). The terms “system” and “network” in the embodiments of this application are often used interchangeably, and the described technology can be used not only for the above systems and radio technologies, but also for other systems and radio technologies. The following description describes a New Radio (NR) system for example objectives, and NR terms are used in most of the description below, but these technologies are also applicable to applications other than NR system applications, such as a 6^{th} Generation (6G) communication system.

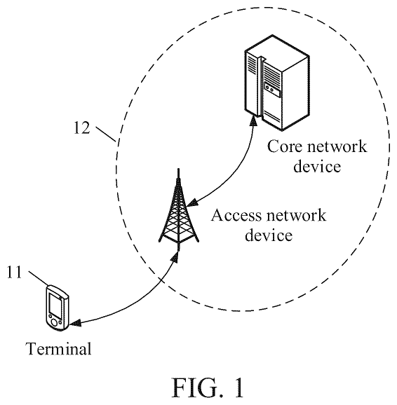

FIG. 1 is a block diagram of a wireless communication system to which the embodiments of this application are applicable. The radio communication system includes a terminal 11 and a network-side device 12. The terminal 11 may be a terminal-side device such as a mobile phone, a tablet personal computer, a laptop computer or referred to as a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle-mounted user equipment (VUE), a pedestrian user equipment (PUE), a smart home (a home device with a wireless communication function, such as a refrigerator, a TV, a washing machine, or furniture), a game console, a personal computer (PC), a teller machine, or a self-service machine. The wearable device includes: a smart watch, a smart band, smart earphones, smart glasses, smart jewelry (a smart bracelet, a smart chain bracelet, a smart ring, a smart necklace, a smart anklet, or a smart chain anklet), a smart wristband, a smart clothing, or the like. It should be noted that, a specific type of the terminal 11 is not limited in the embodiments of this application. The network-side device 12 may include an access network device or a core network device, where the access network device may also be referred to as a radio access network device, a Radio Access Network (RAN), a radio access network function, or a radio access network unit. The access network device may include a base station, a WLAN access point, a Wi-Fi node, or the like. The base station may be referred to as a NodeB, an evolved nodeB (eNB), an access point, a Base Transceiver Station (BTS), a radio base station, a radio transceiver, a Basic Service Set (BSS), an Extended Service Set (ESS), a home nodeB, a home evolved nodeB, a Transmitting Receiving Point (TRP), or another appropriate term in the field, as long as the same technical effect is achieved. The base station is not limited to a specific technical term. It should be noted that, a base station in the NR system is used as an example for description in the embodiments of this application, and a specific type of the base station is not limited. The core network device may include, but is not limited to, at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM) function, a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), or the like. It should be noted that, a core network device in the NR system is used as an example for description in the embodiments of this application, and a specific type of the core network device is not limited.

A method for obtaining location information provided in the embodiments of this application is described below through some embodiments and application scenarios thereof with reference to the accompanying drawings.

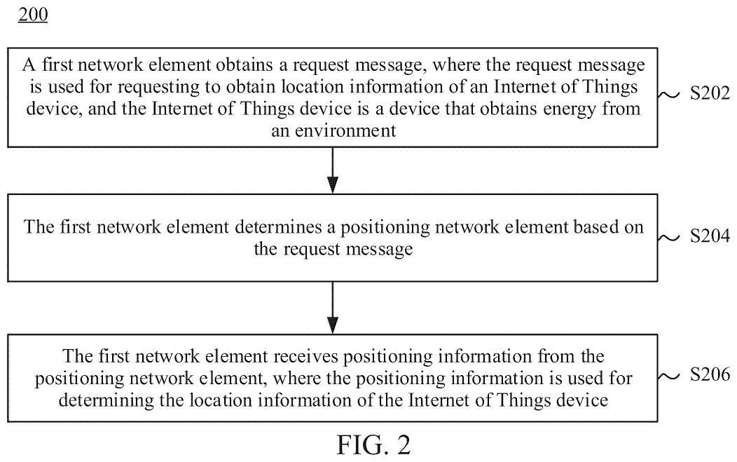

As shown in FIG. 2, an embodiment of this application provides a method 200 for obtaining location information. The method may be performed by a first network element. In other words, the method may be performed by software or hardware installed in the first network element. The method includes the following steps.

S202: The first network element obtains a request message, where the request message is used for requesting to obtain location information of an Internet of Things device, and the Internet of Things device is a device that obtains energy from an environment.

In the embodiments of this application, the first network element may be a mobility management function, for example, a first AMF; or the first network element may be a network exposure function or a unified data management function. A positioning network element described later may be configured to assist the first network element in obtaining positioning information of the Internet of Things device. The positioning network element may include, for example, a first terminal (for example, a mobile phone) or an access network device (for example, a base station).

In an example, the first network element is a mobility management function, and the positioning network element is a location management function, for example, an LMF. In another example, the first network element is a mobility management function, and the positioning network element includes at least one of the following: a first terminal or an access network device. In another example, the first network element is a location management function, and the positioning network element includes at least one of the following: a first terminal or an access network device. In still another example, the first network element is a network exposure function or a unified data management function, and the positioning network element is a mobility management function or a location management function.

In some embodiments, the first network element is the mobility management function, and the positioning network element is the location management function; and the method further includes the following step: sending, by the mobility management function, information about a first terminal to the location management function, where the first terminal is configured to assist in obtaining the positioning information. In other words, the positioning information is sent and received between the first terminal and the Internet of Things device, so that the first terminal obtains the positioning information of the Internet of Things device.

For the first terminal described in the foregoing examples, in some embodiments, subscription data or capability information of the first terminal allows the first terminal to participate in positioning of the Internet of Things device.

In some embodiments, the request message includes at least one of the following: identification information of the Internet of Things device, service level information, or information about a possible location of the Internet of Things device. In some embodiments, the service level information includes at least one of the following: positioning accuracy information, positioning time information, positioning range information, or level indication information.

In some embodiments, the first network element is the mobility management function; and that the first network element obtains a request message includes: receiving, by the mobility management function, a request message from a second terminal, where subscription data of the second terminal allows the second terminal to request to obtain the location information of the Internet of Things device; or receiving, by the mobility management function, a request message from a network exposure function.

S204: The first network element determines a positioning network element based on the request message.

As described above, the request message may include at least one of the identification information of the Internet of Things device, the service level information, or the information about the possible location of the Internet of Things device. In the step, the first network element may determine the positioning network element based on at least one of the foregoing parameters in the request message.

In some embodiments, the first network element may determine the positioning network element based on the information about the possible location of the Internet of Things device; or the first network element may determine one or more positioning network elements based on capability information of a plurality of positioning network elements stored in the first network element.

In some embodiments, that the first network element determines a positioning network element based on the request message includes: sending, by the first network element, a location request message to the positioning network element, where the location request message is used for requesting to obtain the location information of the Internet of Things device. For content included in the location request message, reference may be made to content of the request message in S202.

S206: The first network element receives the positioning information from the positioning network element, where the positioning information is used for determining the location information of the Internet of Things device.

In some embodiments, the positioning information includes at least one of the following: (1) identification information of a cell in which the Internet of Things device is located; (2) identification information of a tracking area in which the Internet of Things device is located; (3) geographical location information of the Internet of Things device; (4) relative location information of the Internet of Things device; or (5) a positioning reference signal measurement result of the Internet of Things device.

The relative location information of the Internet of Things device may be relative location information between the Internet of Things device and the positioning network element, or may be relative location information that is collected by the positioning network element and that is between the Internet of Things device and a network element.

In some embodiments, after the first network element receives the positioning information from the positioning network element, the method further includes: processing, by the first network element, the positioning information to obtain the location information of the Internet of Things device.

This embodiment of this application further includes: sending, by the first network element, a location request message to the positioning network element, where the location request message is used for requesting to obtain the location information of the Internet of Things device. The step may occur before S206.

It should be noted that, parameters of the location request message may be the same as or different from those in the request message in S202. For example, the location request message may include one or more parameters in the request message in S202.

It should be noted that, “positioning information” and “location information” described in the embodiments of this application may be an equivalent relationship in some examples. For example, the “positioning information” and the “location information” may be the geographical location information of the Internet of Things device. In some other examples, the positioning information is similar to intermediate information, and the location information of the Internet of Things device may be finally obtained based on the positioning information.

In the method for obtaining location information provided in this embodiment of this application, after a request message is obtained, a first network element may determine a positioning network element based on the request message. The positioning network element may obtain positioning information of an Internet of Things device. The first network element receives the positioning information from the positioning network element. In this embodiment of this application, the positioning network element assists in obtaining location information of the Internet of Things device, so that when the Internet of Things device is far away from or blocked from a base station of a mobile network, the location information of the Internet of Things device can still be obtained through the positioning network element, thereby implementing positioning of the Internet of Things device.

It should be noted that, an example in which the location information of the Internet of Things device is obtained is used for description in this embodiment of this application. However, the method described in this embodiment may also be used for communication between an application function or a terminal device and the Internet of Things device. In this case, the request message in this embodiment may be replaced with a communication request message of the Internet of Things device. The first network element may send a communication request to the terminal device (for example, a positioning network element) that communicates with the Internet of Things device, to communicate with the Internet of Things device through the terminal device.

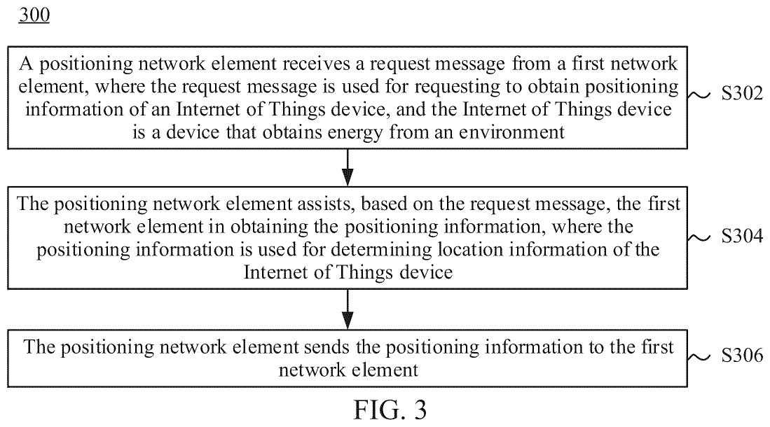

The method for obtaining location information according to this embodiment of this application is described above in detail with reference to FIG. 2. A method for obtaining location information according to another embodiment of this application is described below in detail with reference to FIG. 3. It may be understood that, descriptions of interaction between the positioning network element and the first network element described from a positioning network element side are the same as or correspond to descriptions of interaction between the positioning network element and the first network element on a first network element side in the method shown in FIG. 2. To avoid repetition, related descriptions are appropriately omitted.

FIG. 3 is a schematic flowchart of an implementation of a method for obtaining location information according to an embodiment of this application. The method may be applied to a positioning network element side. As shown in FIG. 3, the method 300 includes the following steps.

S302: A positioning network element receives a request message from a first network element, where the request message is used for requesting to obtain positioning information of an Internet of Things device, and the Internet of Things device is a device that obtains energy from an environment.

In some embodiments, the request message includes at least one of the following: identification information of the Internet of Things device, service level information, or information about a possible location of the Internet of Things device.

In some embodiments, the service level information includes at least one of the following: positioning accuracy information, positioning time information, positioning range information, or level indication information.

For example, the positioning network element is a first terminal. In some embodiments, subscription data or capability information of the first terminal allows the first terminal to participate in positioning of the Internet of Things device.

S304: The positioning network element assists, based on the request message, the first network element in obtaining the positioning information, where the positioning information is used for determining location information of the Internet of Things device.

For example, in the step, the positioning network element positions the Internet of Things device by using a positioning method. The positioning method includes: For example, the positioning network element sends a positioning reference signal to the Internet of Things device, and measures a positioning reference signal reflected by the Internet of Things device, to obtain the positioning information of the Internet of Things device; or the positioning network element sends a positioning reference signal to the Internet of Things device, and receives a measurement result for the positioning reference signal from the Internet of Things device.

In some embodiments, the positioning information includes at least one of the following: (1) identification information of a cell in which the Internet of Things device is located; (2) identification information of a tracking area in which the Internet of Things device is located; (3) geographical location information of the Internet of Things device; (4) relative location information of the Internet of Things device; or (5) a positioning reference signal measurement result of the Internet of Things device.

S306: The positioning network element sends the positioning information to the first network element.

In the method for obtaining location information provided in this embodiment of this application, after a request message is received from a first network element, a positioning network element may assist, based on the request message, the first network element in obtaining positioning information. In this embodiment of this application, the positioning network element assists in obtaining location information of an Internet of Things device, so that when the Internet of Things device is far away from or blocked from a base station of a mobile network, the location information of the Internet of Things device can still be obtained, thereby implementing positioning of the Internet of Things device.

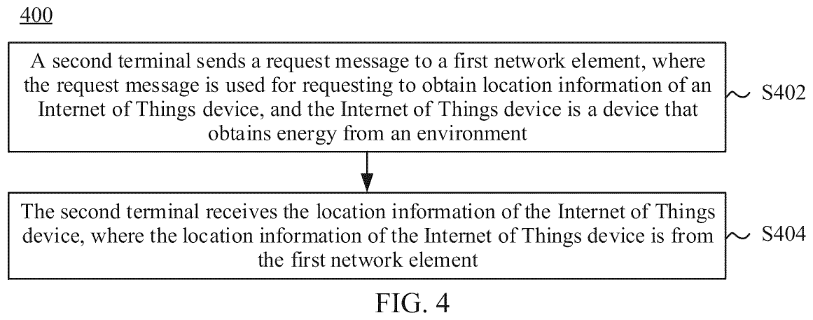

FIG. 4 is a schematic flowchart of an implementation of a method for obtaining location information according to an embodiment of this application. The method may be applied to a second terminal. As shown in FIG. 4, the method 400 includes the following steps.

S402: The second terminal sends a request message to a first network element, where the request message is used for requesting to obtain location information of an Internet of Things device, and the Internet of Things device is a device that obtains energy from an environment.

S404: The second terminal receives the location information of the Internet of Things device, where the location information of the Internet of Things device is from the first network element.

In the method for obtaining location information provided in this embodiment of this application, a second terminal sends a request message to a first network element, where the request message is used for requesting to obtain location information of an Internet of Things device. The second terminal receives the location information of the Internet of Things device, where the location information of the Internet of Things device is from the first network element. In this embodiment of this application, the first network element obtains the location information of the Internet of Things device, so that when the Internet of Things device is far away from or blocked from a base station of a mobile network, the location information of the Internet of Things device can still be obtained, thereby implementing positioning of the Internet of Things device.

In some embodiments, the request message includes at least one of the following: identification information of the Internet of Things device, service level information, or information about a possible location of the Internet of Things device.

In some embodiments, the service level information includes at least one of the following: positioning accuracy information, positioning time information, positioning range information, or level indication information.

In some embodiments, the first network element is a mobility management function or a location management function.

In some embodiments, subscription data of the second terminal allows the second terminal to request the location information of the Internet of Things device.

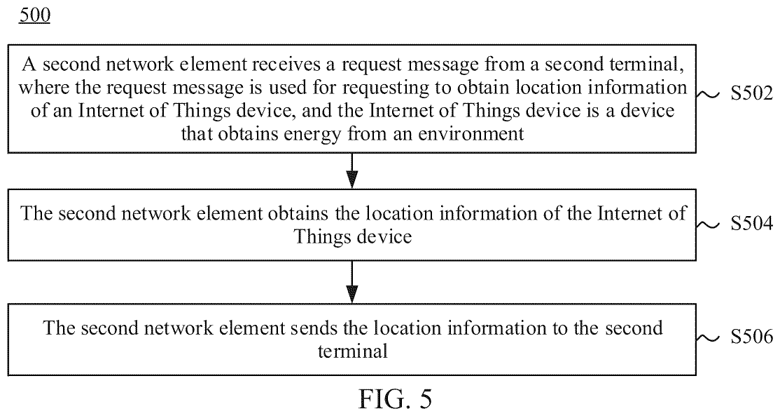

FIG. 5 is a schematic flowchart of an implementation of a method for obtaining location information according to an embodiment of this application. The method may be applied to a second network element. As shown in FIG. 5, the method 500 includes the following steps.

S502: The second network element receives a request message from a second terminal, where the request message is used for requesting to obtain location information of an Internet of Things device, and the Internet of Things device is a device that obtains energy from an environment.

In some embodiments, the request message includes at least one of the following: identification information of the Internet of Things device, service level information, or information about a possible location of the Internet of Things device.

In some embodiments, the service level information includes at least one of the following: positioning accuracy information, positioning time information, positioning range information, or level indication information.

The second network element is a mobility management function or a location management function. For example, the second network element is a second AMF.

S504: The second network element obtains the location information of the Internet of Things device.

In some embodiments, that the second network element obtains the location information of the Internet of Things device includes: determining, by the second network element, a mobility management network element; sending, by the second network element, the request message to the mobility management network element, where the mobility management network element is configured to obtain the location information of the Internet of Things device; and receiving, by the second network element, the location information of the Internet of Things device, where the location information of the Internet of Things device is from the mobility management network element.

The determining, by the second network element, a mobility management network element includes: determining, by the second network element, the mobility management network element based on coverage of the mobility management network element.

S506: The second network element sends the location information to the second terminal.

In the method for obtaining location information provided in this embodiment of this application, a second network element receives a request message from a second terminal, where the request message is used for requesting to obtain location information of an Internet of Things device. The second network element obtains the location information of the Internet of Things device. In this embodiment of this application, the second network element obtains the location information of the Internet of Things device, so that when the Internet of Things device is far away from or blocked from a base station of a mobile network, the location information of the Internet of Things device can still be obtained, thereby implementing positioning of the Internet of Things device.

It should be noted that, in FIG. 4 or FIG. 5, the second terminal may be a terminal device of a user of the Internet of Things device. Through the method described in FIG. 4 or FIG. 5, the user of the Internet of Things device may perform querying in a communication network by using the terminal device, to obtain the location information of the Internet of Things device.

To describe the method for obtaining location information provided in the embodiments of this application in detail, the following describes the method with reference to a plurality of specific embodiments.

### Embodiment 1

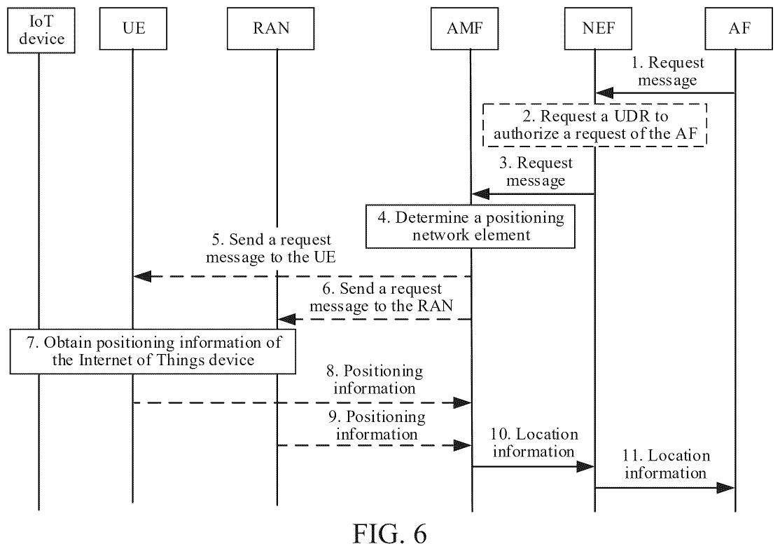

As shown in FIG. 6, in this embodiment, the following steps are included.

Step 1: An application function (AF) sends a request message to a network exposure function (NEF).

The request message is used for obtaining location information of an Internet of Things device.

The request message may include identification information of the Internet of Things device; and in some embodiments, may further include a service level, and an area in which the Internet of Things device may be located.

The service level indicates a request level of current request information. For example, the service level may include positioning accuracy, positioning time, a positioning range, and the like.

The positioning accuracy indicates accuracy of the obtained location information. For example, the positioning accuracy is 3 m.

The positioning time indicates time for obtaining the location information. For example, if the positioning time is 1 hour, it indicates that the location information needs to be obtained within 1 hour.

The positioning range indicates that the location information is obtained within a specific range. For example, if the positioning range is an area A, it indicates that the location information of the Internet of Things device is searched for within the range of the area A. For another example, if the positioning range is 1 km around a location B, it indicates that the location information of the Internet of Things device is searched for in a range of 1 km around the location B. The location B in the positioning range may be an area range. It should be noted that, the location B may be represented by the area in which the Internet of Things device may be located. In this case, the positioning range and the area in which the Internet of Things device may be located may be represented by using a same parameter.

The service level may further include a level indication. For example, the level indication may be valued as high, medium, low, or default. The value corresponds to a service policy provided by a mobile network. Each policy corresponds to positioning accuracy, positioning time, and a positioning range that are set by an operator.

The area in which the Internet of Things device may be located may be information about a location at which the Internet of Things device has ever arrived.

It should be noted that, the area in which the Internet of Things device may be located and the positioning range may be represented by using location information of the mobile network (for example, a cell identifier or a tracking area identifier), or may be represented by using geographical location information (for example, latitude and longitude, a street, or an administrative district).

For example, the AF sends an event exposure subscribe (Nnef_EventExposure_Subscribe) message to the NEF, to request to obtain the location information of the Internet of Things device.

Step 2: The NEF authorizes the request of the AF for the location information of the Internet of Things device.

In an implementation, the NEF performs authorization on a received request message. For example, the NEF may perform the foregoing authorization based on operator configuration information or a protocol between the operator and the AF. For example, if the configuration information or the protocol allows the AF to query the location information of the Internet of Things device in a network of the operator, the NEF authorizes the request for the location information of the Internet of Things device.

Step 2 is optional.

Step 3: The NEF sends a request message to an AMF.

The NEF may send the request message to the AMF through a UDM, or may directly send the request message to the AMF.

For example, the NEF sends a Nudm_EventExposure_Subscribe message to the UDM, and the UDM sends an event exposure subscribe (Namf_EventExposure_Subscribe) message to the AMF.

The UDM may determine the AMF based on a service level and/or an area in which the Internet of Things device may be located in the request message, and send the request message to the AMF. For example, if the service level indicates that the positioning range is an area A, the UDM sends the request message to the AMF covering the area A. If the area in which the Internet of Things device may be located is an area B, the UDM sends the request message to the AMF covering the area A and the area B. The area A may include the area B, and the area A may also be a subset of the area B. This is not limited in the technical solution. The UDM may determine one or more AMFs. For example, when the service level and/or the area in which the Internet of Things device may be located in the request message are covered by a plurality of AMFs, the request message may be sent to the plurality of AMFs.

It should be noted that, the request message in Step 3 may include some or all of the parameters in the request message in Step 1, but parameter names or expression forms may be the same or different. Message names of the request message in Step 3 and the request message in Step 1 may also be the same or different. This is not limited in this embodiment of this application. For example, the request message in Step 3 includes identification information of the Internet of Things device; and in some embodiments, may further include a service level, and an area in which the Internet of Things device may be located.

It should be noted that, the NEF may send the request message to one or more AMFs. For example, when the service level and/or the area in which the Internet of Things device may be located in the request message are covered by a plurality of AMFs, the request message may be sent to the plurality of AMFs.

Step 4: The AMF determines a positioning network element that obtains the location information of the Internet of Things device.

The positioning network element includes at least one of the following: one or more UEs or one or more RANs.

In some embodiments, the AMF may determine the positioning network element based on the request message. For example, the AMF determines, based on positioning accuracy, a positioning network element that supports the positioning accuracy. The AMF may determine the positioning network element based on a positioning range. The AMF may determine the positioning network element based on an area in which the Internet of Things device may be located.

In some embodiments, the AMF may determine the positioning network element based on capability information of a positioning network element of the Internet of Things device stored in the AMF.

In some embodiments, when the positioning network element includes the UE, subscription data of the UE is determined to allow the UE to obtain the location information of the Internet of Things device.

Step 5: The AMF sends a request message to the UE. The UE is the positioning network element of the Internet of Things device in Step 4.

The request message includes identification information of the Internet of Things device; in some embodiments, may further include positioning accuracy and a positioning range; and in some embodiments, may further include a positioning method. The request message is used for requesting the location information of the Internet of Things device.

For example, the request message is a NAS message.

It should be noted that, the AMF may send the request message to one or more UEs.

Step 6: The AMF sends a request message to the RAN. The RAN is the positioning network element of the Internet of Things device in Step 4.

The request message includes identification information of the Internet of Things device; in some embodiments, may further include positioning accuracy and a positioning range; and in some embodiments, may further include a positioning method. The request message is used for requesting the location information of the Internet of Things device.

For example, the request message may be an NGAP message or a NAS message. If the request message is the NAS message, the RAN supports a NAS protocol stack.

It should be noted that, the AMF may send the request message to one or more RANs.

It should be noted that, the request message in Step 5 or Step 6 may include some or all of the parameters in the request message in Step 3, but parameter names or expression forms may be the same or different. Message names of the request message in Step 5 or Step 6 and the request message in Step 3 may also be the same or different. This is not limited in this embodiment of this application.

Step 7: The UE and/or the RAN performs a process of obtaining the location information of the Internet of Things device.

The UE or the RAN positions the Internet of Things device by using the positioning method. The positioning method includes: At least one of the UE, the RAN, and the Internet of Things device performs at least one of sending a positioning reference signal or measuring a positioning reference signal.

Step 8: The UE reports obtained positioning information of the Internet of Things device to the AMF.

Step 9: The RAN reports obtained positioning information of the Internet of Things device to the AMF.

It should be noted that, in Step 8 and Step 9, the UE or the RAN may report a positioning reference signal measurement result to the AMF. In some embodiments, the AMF performs calculation based on the measurement result, to obtain the location information of the Internet of Things device.

It should be noted that, the positioning information in Step 8 and Step 9 may indicate that the positioning fails, to notify the AMF that the positioning of the Internet of Things device fails. For example, when the UE or the RAN does not find the Internet of Things device, or does not establish a connection to the Internet of Things device, or does not receive a message from the Internet of Things device, the UE or the RAN may send the positioning information to the AMF to indicate that the positioning fails. The UE or the RAN may not send the positioning information to the AMF to indicate that the positioning fails. In other words, Step 8 and Step 9 are optional.

The AMF may further determine the location information of the Internet of Things device based on positioning information from the plurality of UEs or RANs. If all positioning information received by the AMF indicates that the positioning fails, the AMF also determines that the positioning of the Internet of Things device fails.

It should be noted that, all or some of Step 5 to Step 9 may be performed. For example, Step 5, Step 7, and Step 8 may be performed, or Step 6, Step 7, and Step 9 may be performed.

Step 10: The amf sends the location information of the internet of things device to the NEF.

It should be noted that, if the AMF determines that the positioning of the Internet of Things device fails, in Step 10, the location information indicates that the positioning of the Internet of Things device fails, or the AMF sends positioning failure information to the NEF, where the information indicates that the positioning of the Internet of Things device fails.

Step 11: The NEF sends the location information of the Internet of Things device to the AF.

It should be noted that, the location information in Step 11 may be the same as or different from the location information in Step 10. For example, the NEF obtains the location information (for example, cell information) of the Internet of Things device in a communication network in Step 10, and the NEF converts the location information into geographical location information (for example, longitude and latitude information or street location information), and sends the geographical location information to the AF in Step 11.

It should be noted that, the NEF may further determine the location information of the Internet of Things device based on positioning information from the plurality of AMFs. If all positioning information received by the NEF indicates that the positioning fails, the NEF may also determine that the positioning of the Internet of Things device fails. If the positioning of the Internet of Things device fails, in Step 11, the location information indicates that the positioning of the Internet of Things device fails, or the NEF sends positioning failure information to the AF, where the information indicates that the positioning of the Internet of Things device fails. It should be noted that, the AMF in the foregoing embodiment may be replaced with a location management function LMF.

In one implementation, the AMF in all steps in the foregoing embodiment is replaced with the LMF.

In another implementation, the AMF in Step 4 to Step 9 in the foregoing embodiment may be replaced with the LMF. Before Step 4, the AMF may send a request message to the LMF. After Step 9, the LMF sends the location information of the Internet of Things device to the AMF.

It should be noted that, the UE or the RAN in the foregoing embodiment may be a reader/writer of the Internet of Things device.

### Embodiment 2

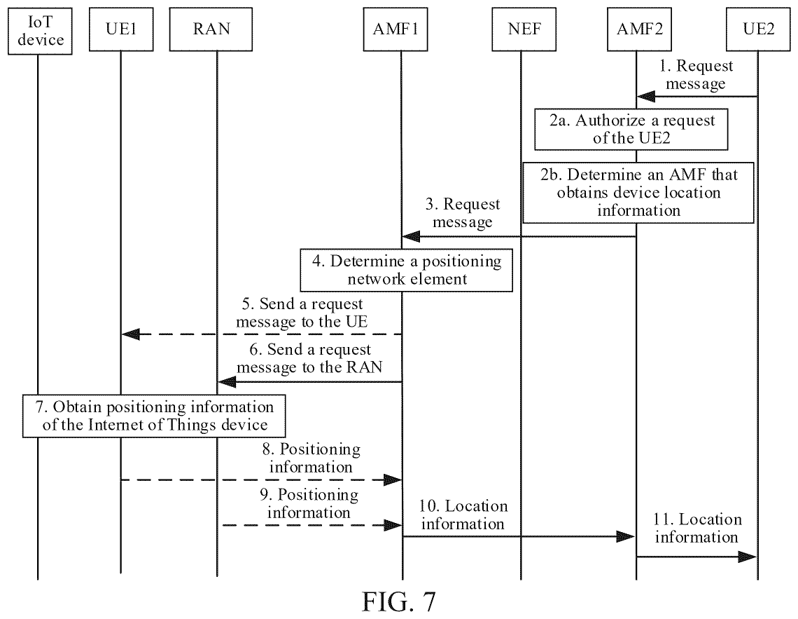

As shown in FIG. 7, in this embodiment, the following steps are included.

Step 1: A UE2 sends a request message to an AMF2.

For the request message, reference may be made to descriptions in Embodiment 1.

For example, a user uses the UE2 to search for an Internet of Things device. The request message is a NAS message.

Step 2: The AMF2 authorizes a location information request of the UE2.

For example, the AMF2 determines, based on subscription data of the UE2, that the UE2 is allowed to request location information of the Internet of Things device. In some embodiments, the AMF2 determines, based on the subscription data of the UE2, that the UE2 is allowed to use a service level in the request message.

In some embodiments, the AMF2 determines an AMF1 that obtains the device location. When the Internet of Things device needs to be searched for outside coverage of the AMF2, the AMF2 needs to determine the AMF1 that can serve a search range.

Step 3: The AMF2 sends a request message to the AMF1.

Step 4: The AMF1 determines a positioning network element that obtains the location information of the Internet of Things device.

Step 5: The AMF1 sends a request message to the UE1. The UE1 is the positioning network element of the Internet of Things device in Step 4.

Step 6: The AMF1 sends a request message to a RAN. The RAN is the positioning network element of the Internet of Things device in Step 4.

Step 7: The UE1 and/or the RAN performs a process of obtaining the location information of the Internet of Things device.

Step 8: The UE1 reports obtained positioning information of the Internet of Things device to the AMF1.

Step 9: The RAN reports obtained positioning information of the Internet of Things device to the AMF1. For Step 4 to Step 9, reference may be made to descriptions of Step 4 to Step 9 in Embodiment 1. The AMF and the UE in Embodiment 1 are respectively replaced with the AMF1 and the UE1 in this embodiment of this application.

Step 10: The AMF1 sends the location information of the Internet of Things device to the AMF2.

It should be noted that, if the positioning of the Internet of Things device fails, in Step 10, the location information indicates that the positioning of the Internet of Things device fails, or the AMF1 sends positioning failure information to the AMF2, where the information indicates that the positioning of the Internet of Things device fails.

Step 11: The AMF2 sends the location information of the Internet of Things device to the UE2.

It should be noted that, if the positioning of the Internet of Things device fails, in Step 11, the location information indicates that the positioning of the Internet of Things device fails, or the AMF2 sends positioning failure information to the UE2, where the information indicates that the positioning of the Internet of Things device fails.

If the UE2 has not been under the AMF2, for example, the AMF2 finds that there is no context information of the UE2 locally, the following steps may be performed.

In an implementation, the AMF2 requests, from a UDM, an AMF that currently serves the UE2, for example, an AMF3, and the AMF2 sends the location information of the Internet of Things device to the AMF3.

In another implementation, the AMF2 sends a failure message or a reject message to the AMF1, to indicate that the AMF2 currently does not serve the UE2. The AMF1 requests, from a UDM, an AMF that currently serves the UE2, for example, an AMF3, and the AMF1 sends the location information of the Internet of Things device to the AMF3.

It should be noted that, the AMF1 and the AMF2 may be the same or different. When the AMF1 and the AMF2 are the same, interaction between the AMF1 and the AMF2 in the foregoing method may be omitted.

It should be noted that, the AMF in the foregoing embodiment may be replaced with a location management function LMF.

In one implementation, the AMF in all steps in the foregoing embodiment is replaced with the LMF.

In another implementation, the AMF1 in Step 4 to Step 9 in the foregoing embodiment may be replaced with the LMF. Before Step 4, the AMF1 may send a request message to the LMF. After Step 9, the LMF sends the location information of the Internet of Things device to the AMF1.

It should be noted that, the ue or the ran in the foregoing embodiment may be a reader/writer.

In addition to the descriptions in the foregoing embodiment, in this embodiment, an example in which the location information of the Internet of Things device is obtained is used for description. However, the method described in this embodiment may also be used for communication between an application function or a terminal device and the Internet of Things device. In this case, the request message in this embodiment may be replaced with a communication request message of the Internet of Things device. The AMF may send a communication request to the terminal device that communicates with the Internet of Things device, to communicate with the Internet of Things device through the terminal device.

An execution entity of the method for obtaining location information provided in the embodiments of this application may be an apparatus for obtaining location information. In the embodiments of this application, an example in which the apparatus for obtaining location information executes the method for obtaining location information is used to describe the apparatus for obtaining location information provided in the embodiments of this application.

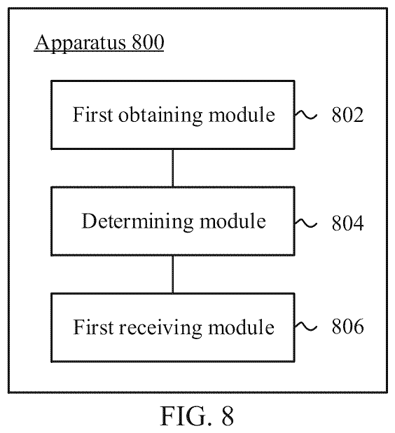

FIG. 8 is a schematic structural diagram of an apparatus for obtaining location information according to an embodiment of this application. The apparatus may correspond to an AMF, an NEF, or a UDM in other embodiments. As shown in FIG. 8, an apparatus 800 includes the following modules.

A first obtaining module 802 is configured to obtain a request message, where the request message is used for requesting to obtain location information of an Internet of Things device, and the Internet of Things device is a device that obtains energy from an environment.

A determining module 804 is configured to determine a positioning network element based on the request message.

A first receiving module 806 is configured to receive positioning information from the positioning network element, where the positioning information is used for determining the location information of the Internet of Things device.

In the apparatus for obtaining location information provided in this embodiment of this application, after a request message is obtained, a positioning network element may be determined based on the request message. The positioning network element may obtain positioning information of an Internet of Things device. The positioning information is received from the positioning network element. In this embodiment of this application, the positioning network element assists in obtaining location information of the Internet of Things device, so that when the Internet of Things device is far away from or blocked from a base station of a mobile network, the location information of the Internet of Things device can still be obtained through the positioning network element, thereby implementing positioning of the Internet of Things device.

In an embodiment, the apparatus is a mobility management function, and the positioning network element is a location management function; or the apparatus is a mobility management function, and the positioning network element includes at least one of the following: a first terminal or an access network device; or the apparatus is a location management function, and the positioning network element includes at least one of the following: a first terminal or an access network device; or the apparatus is a network exposure function or a unified data management function, and the positioning network element is a mobility management function or a location management function.

In an embodiment, the positioning network element is configured to assist the apparatus in obtaining the positioning information.

For the apparatus 800 in this embodiment of this application, reference may be made to procedures of the method 200 in the embodiments of this application. In addition, the units/modules and the foregoing other operations and/or functions in the apparatus 800 respectively implement the corresponding procedures in the method 200, and can achieve the same or equivalent technical effects. For brevity, details are not described herein again.

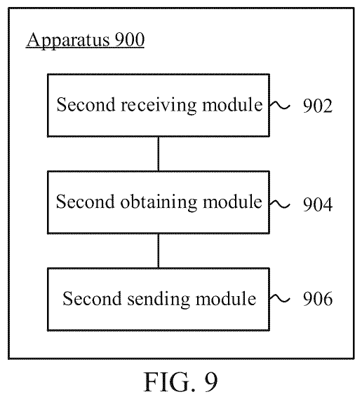

FIG. 9 is a schematic structural diagram of an apparatus for obtaining location information according to an embodiment of this application. The apparatus may correspond to a first terminal or an access network device in other embodiments. As shown in FIG. 9, an apparatus 900 includes the following modules.

A second receiving module 902 is configured to receive a request message from a first network element, where the request message is used for requesting to obtain positioning information of an Internet of Things device, and the Internet of Things device is a device that obtains energy from an environment.

A second obtaining module 904 is configured to assist, based on the request message, the first network element in obtaining the positioning information, where the positioning information is used for determining location information of the Internet of Things device.

A second sending module 906 is configured to send the positioning information to the first network element.

In the apparatus for obtaining location information provided in this embodiment of this application, after a request message is received from a first network element, the first network element may be assisted in obtaining positioning information based on the request message. In this embodiment of this application, the apparatus for obtaining location information assists in obtaining location information of an Internet of Things device, so that when the Internet of Things device is far away from or blocked from a base station of a mobile network, the location information of the Internet of Things device can still be obtained, thereby implementing positioning of the Internet of Things device.

For the apparatus 900 in this embodiment of this application, reference may be made to procedures of the method 300 in the embodiments of this application. In addition, the units/modules and the foregoing other operations and/or functions in the apparatus 900 respectively implement the corresponding procedures in the method 300, and can achieve the same or equivalent technical effects. For brevity, details are not described herein again.

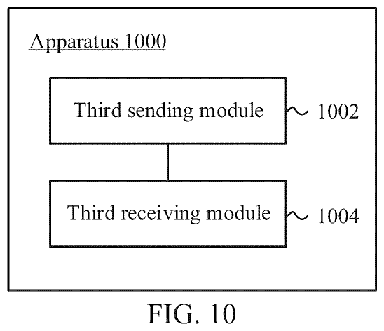

FIG. 10 is a schematic structural diagram of an apparatus for obtaining location information according to an embodiment of this application. The apparatus may correspond to a second terminal in other embodiments. As shown in FIG. 10, an apparatus 1000 includes the following modules.

A third sending module 1002 is configured to send a request message to a first network element, where the request message is used for requesting to obtain location information of an Internet of Things device, and the Internet of Things device is a device that obtains energy from an environment.

A third receiving module 1004 is configured to receive the location information of the Internet of Things device, where the location information of the Internet of Things device is from the first network element.

In the apparatus for obtaining location information provided in this embodiment of this application, a request message is sent to a first network element, where the request message is used for requesting to obtain location information of an Internet of Things device. The location information of the Internet of Things device is received from the first network element. In this embodiment of this application, the first network element obtains the location information of the Internet of Things device, so that when the Internet of Things device is far away from or blocked from a base station of a mobile network, the location information of the Internet of Things device can still be obtained, thereby implementing positioning of the Internet of Things device.

For the apparatus 1000 in this embodiment of this application, reference may be made to procedures of the method 400 in the embodiments of this application. In addition, the units/modules and the foregoing other operations and/or functions in the apparatus 1000 respectively implement the corresponding procedures in the method 400, and can achieve the same or equivalent technical effects. For brevity, details are not described herein again.

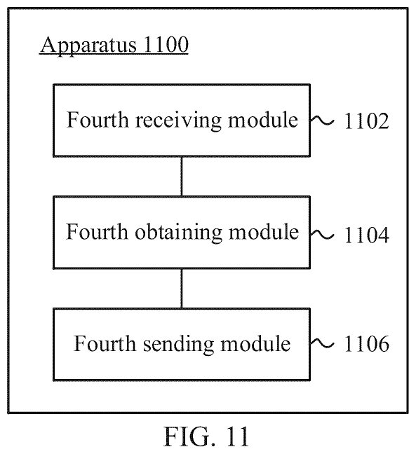

FIG. 11 is a schematic structural diagram of an apparatus for obtaining location information according to an embodiment of this application. The apparatus may correspond to a network-side device in other embodiments. As shown in FIG. 11, an apparatus 1100 includes the following modules.

A fourth receiving module 1102 is configured to receive a request message from a second terminal, where the request message is used for requesting to obtain location information of an Internet of Things device, and the Internet of Things device is a device that obtains energy from an environment.

A fourth obtaining module 1104 is configured to obtain the location information of the Internet of Things device.

A fourth sending module 1106 is configured to send the location information to the second terminal.

In the apparatus for obtaining location information provided in this embodiment of this application, a request message is received from a second terminal, where the request message is used for requesting to obtain location information of an Internet of Things device. The location information of the Internet of Things device is obtained. In this embodiment of this application, the apparatus for obtaining location information obtains the location information of the Internet of Things device, so that when the Internet of Things device is far away from or blocked from a base station of a mobile network, the location information of the Internet of Things device can still be obtained, thereby implementing positioning of the Internet of Things device.

In an embodiment, the obtaining module 1104 is further configured to: determine a mobility management network element; send the request message to the mobility management network element, where the mobility management network element is configured to obtain the location information of the Internet of Things device; and receive the location information of the Internet of Things device, where the location information of the Internet of Things device is from the mobility management network element.

For the apparatus 1100 in this embodiment of this application, reference may be made to procedures of the method 500 in the embodiments of this application. In addition, the units/modules and the foregoing other operations and/or functions in the apparatus 1100 respectively implement the corresponding procedures in the method 500, and can achieve the same or equivalent technical effects. For brevity, details are not described herein again.

The apparatus for obtaining location information in the embodiments of this application may be an electronic device, such as an electronic device with an operating system; or may be a component in an electronic device, such as an integrated circuit or a chip. The electronic device may be a terminal or another device other than the terminal. For example, the terminal may include, but is not limited to, the types of the terminal 11 listed above, and the another device may be a server, a Network Attached Storage (NAS), or the like, which are not specifically limited in the embodiments of this application.

The apparatus for obtaining location information provided in the embodiments of this application can implement all processes implemented in the method embodiments in FIG. 2 to FIG. 5, and can achieve the same technical effects. To avoid repetition, details are not described herein again.

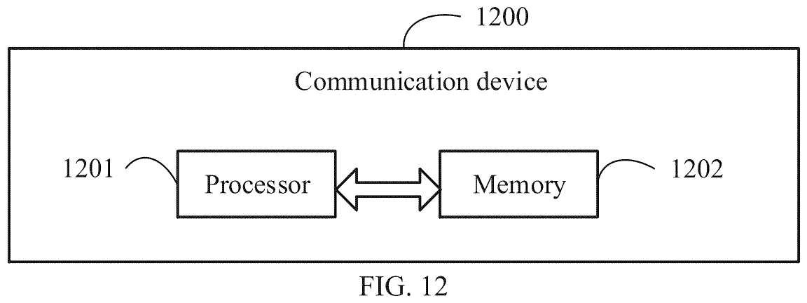

As shown in FIG. 12, an embodiment of this application further provides a communication device 1200, including a processor 1201, a memory 1202, where the memory 1202 stores a program or instructions runnable on the processor 1201. For example, when the communication device 1200 is a terminal, the program or the instructions, when executed by the processor 1201, implement all steps of the embodiments of the method for obtaining location information, and can achieve the same technical effects. When the communication device 1200 is a network-side device, the program or the instructions, when executed by the processor 1201, implement all steps of the embodiments of the method for obtaining location information, and can achieve the same technical effects. To avoid repetition, details are not described herein again.

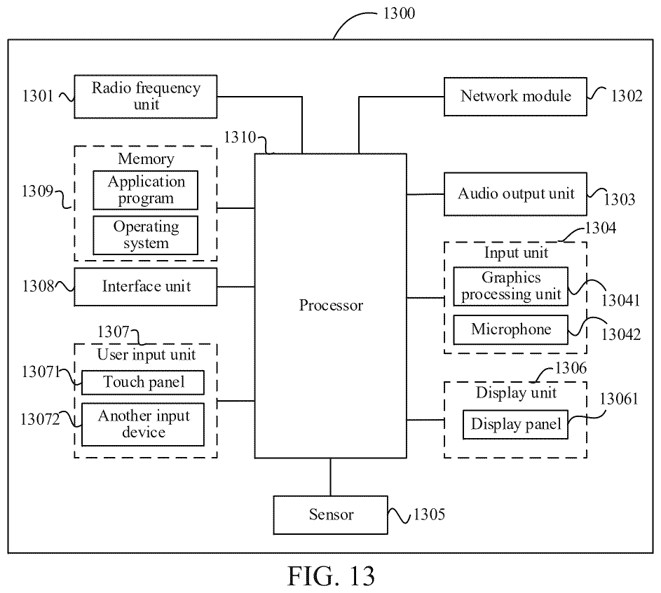

An embodiment of this application further provides a terminal, including a processor and a communication interface, where the processor or the communication interface is configured to implement steps obtained in the embodiment shown in FIG. 3 or FIG. 4. The terminal embodiment corresponds to the foregoing terminal side method embodiment, and each implementation process and implementation of the foregoing method embodiment can be applied to the terminal embodiment, and can achieve the same technical effects. FIG. 13 is a schematic diagram of a hardware structure of a terminal that implements the embodiments of this application.

A terminal 1300 includes, but is not limited to, at least part of components such as a radio frequency unit 1301, a network module 1302, an audio output unit 1303, an input unit 1304, a sensor 1305, a display unit 1306, a user input unit 1307, an interface unit 1308, a memory 1309, and a processor 1310.

A person skilled in the art may understand that the terminal 1300 further includes a power supply (such as a battery) for supplying power to the components. The power supply may logically connect to the processor 1310 by using a power supply management system, thereby implementing functions, such as charging, discharging, and power consumption management, by using the power supply management system. The terminal structure shown in FIG. 13 does not constitute a limitation to the terminal, and the terminal may include more or fewer components than illustrated, or a combination of specific components, or arrangement of different components, which are not described herein again.

It should be understood that, in this embodiment of this application, the input unit 1304 may include a GPU 13041 and a microphone 13042. The graphics processing unit 13041 processes image data of a still picture or a video obtained by an image capture apparatus (such as a camera) in a video capture mode or an image capture mode. The display unit 1306 may include a display panel 13061, for example, the display panel 13061 may be configured in a form such as a liquid crystal display or an organic light-emitting diode. The user input unit 1307 includes at least one of a touch panel 13071 or another input device 13072. The touch panel 13071 is also referred to as a touchscreen. The touch panel 13071 may include a touch detection apparatus and a touch controller. The another input device 13072 may include, but is not limited to, a physical keyboard, a function key (such as a volume control key, a switch key, or the like), a trackball, a mouse, and an operating lever, which is not described in detail herein.

In this embodiment of this application, the radio frequency unit 1301 may transmit, after receiving downlink data from a network-side device, the downlink data to the processor 1310 for processing. In addition, the radio frequency unit 1301 may send uplink data to the network-side device. Generally, the radio frequency unit 1301 includes, but is not limited to, an antenna, an amplifier, a transceiver, a coupler, a low noise amplifier, a duplexer, or the like.

The memory 1309 may be configured to store a software program or instructions, and various data. The memory 1309 may mainly include a first storage area for storing the program or the instructions and a second storage area for storing data, where the first storage area may store an operating system, an application program or instructions required for at least one function (for example, a sound playing function and an image playing function), or the like. In addition, the memory 1309 may include a volatile memory or a non-volatile memory, or the memory 1309 may include both the volatile memory and the non-volatile memory. The non-volatile memory may be a Read-Only Memory (ROM), a Programmable ROM (PROM), an Erasable PROM (EPROM), an Electrically EPROM (EEPROM), or a flash memory. The Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch link DRAM (SLDRAM), or a Direct Rambus RAM (DR RAM). The memory 1309 in this embodiment of this application includes but is not limited to these memories and any other suitable types of memories.

The processor 1310 may include one or more processing units. In some embodiments, the processor 1310 integrates an application processor and a modem. The application processor mainly processes operations related to an operating system, a user interface, an application program, and the like. The modem mainly processes a wireless communication signal, such as a baseband processor. It may be understood that, the foregoing modem may not be integrated into the processor 1310.

The radio frequency unit 1301 may be configured to receive a request message from a first network element, where the request message is used for requesting to obtain positioning information of an Internet of Things device, and the Internet of Things device is a device that obtains energy from an environment; assist, based on the request message, the first network element in obtaining the positioning information, where the positioning information is used for determining location information of the Internet of Things device; and send the positioning information to the first network element. In some embodiments, the radio frequency unit 1301 may be configured to send a request message to a first network element, where the request message is used for requesting to obtain location information of an Internet of Things device, and the Internet of Things device is a device that obtains energy from an environment; and receive the location information of the Internet of Things device, where the location information of the Internet of Things device is from the first network element.

The terminal 1300 provided in this embodiment of this application can implement all processes of the embodiments of the method for obtaining location information, and can achieve the same technical effects. To avoid repetition, details are not described herein again.

An embodiment of this application further provides a network-side device, including a processor and a communication interface, where the processor or the communication interface is configured to implement steps obtained in the embodiment shown in FIG. 2, FIG. 3, or FIG. 5. The network-side device embodiment corresponds to the foregoing network-side device method embodiment, and each implementation process and implementation of the foregoing method embodiment can be applied to the network-side device embodiment, and can achieve the same technical effects.

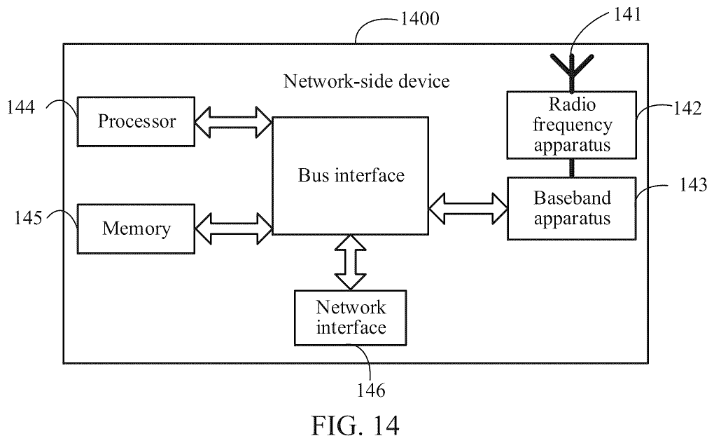

An embodiment of this application further provides a network-side device. As shown in FIG. 14, the network-side device 1400 includes an antenna 141, a radio frequency apparatus 142, a baseband apparatus 143, a processor 144, and a memory 145. The antenna 141 is connected to the radio frequency apparatus 142. In an uplink direction, the radio frequency apparatus 142 receives information by using the antenna 141, and sends the received information to the baseband apparatus 143 for processing. In a downlink direction, the baseband apparatus 143 processes information that is to be sent, and sends the information to the radio frequency apparatus 142. The radio frequency apparatus 142 processes the received information and sends the information by using the antenna 141.

The method executed by the network-side device in the foregoing embodiment can be implemented in the baseband apparatus 143. The baseband apparatus 143 includes a baseband processor.

For example, the baseband apparatus 143 may include at least one baseband board, and a plurality of chips are disposed on the baseband board. As shown in FIG. 14, one chip, for example, the baseband processor, is connected to the memory 145 through a bus interface, to invoke a program in the memory 145, to execute operations of network devices shown in the foregoing method embodiments.

In some embodiments, the network-side device may further include a network interface 146. The interface is, for example, a common public radio interface (CPRI).

The network-side device 1400 in embodiments of this application further includes: instructions or a program stored in the memory 145 and runnable on the processor 144, and the processor 144 invokes the instructions or the program stored in the memory 145 to perform the method executed by various modules shown in FIG. 9, and can achieve the same technical effects. To avoid repetition, details are not described herein again. The network-side device 1400 in this embodiment of this application may be an access network device.

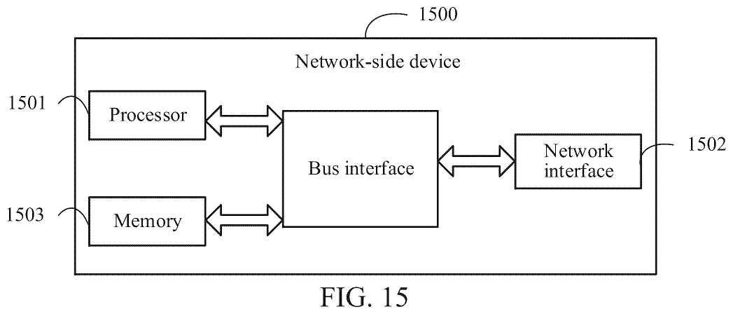

An embodiment of this application further provides a network-side device. As shown in FIG. 15, a network-side device 1500 includes a processor 1501, a network interface 1502, and a memory 1503. The network interface 1502 is, for example, a common public radio interface (CPRI).

The network-side device 1500 in embodiments of this application further includes: instructions or a program stored in the memory 1503 and runnable on the processor 1501, and the processor 1501 invokes the instructions or the program stored in the memory 1503 to perform the method executed by various modules shown in FIG. 8 or FIG. 11, and can achieve the same technical effects. To avoid repetition, details are not described herein again.

An embodiment of this application further provides a readable storage medium, storing a program or instructions. The program or the instructions, when executed by a processor, implements all processes of the embodiments of the method for obtaining location information, and can achieve the same technical effects. To avoid repetition, details are not described herein again.

The processor is the processor in the terminal in the above embodiments. The readable storage medium includes a computer-readable storage medium, for example, a computer read-only memory ROM, a random access memory RAM, a magnetic disk, or an optical disc.

An embodiment of this application further provides a chip, including a processor and a communication interface, where the communication interface is coupled to the processor, and the processor is configured to run a program or instruction, to implement all processes of the embodiments of the method for obtaining location information, and can achieve the same technical effects. To avoid repetition, details are not described herein again.

It should be understood that, the chip mentioned in this embodiment of this application may also be referred to as a system-level chip, a system chip, a chip system, a system on chip, or the like.

An embodiment of this application further provides a computer program/program product, stored in a storage medium. The computer program/program product is executed by at least one processor to implement all processes of the embodiments of the method for obtaining location information, and can achieve the same technical effects. To avoid repetition, details are not described herein again.

An embodiment of this application further provides a system for obtaining location information, including a terminal and a network-side device, where the terminal may be configured to perform steps of the method for obtaining location information, and the network-side device may be configured to perform steps of the method for obtaining location information.

It should be noted that, the term “include”, “comprise”, or any other variation thereof in this specification is intended to cover a non-exclusive inclusion, which specifies the presence of stated processes, methods, objects, or apparatuses, but does not preclude the presence or addition of one or more other processes, methods, objects, or apparatuses. Without more limitations, elements defined by the sentence “including one . . . ” does not exclude that there are still other same elements in the processes, methods, objects, or apparatuses. In addition, it should be noted that the scope of the methods and apparatuses in the implementations of this application is not limited to performing the functions in the order shown or discussed, but may also include performing, according to involved functions, the functions basically simultaneously or in a reverse order. For example, the described methods may be performed in an order different from that described, and various steps may also be added, omitted, or combined. In addition, a feature described with reference to an example may be combined in another example.

Through the descriptions of the foregoing implementations, a person skilled in the art may clearly understand that the method according to the foregoing embodiments may be implemented through software and a necessary general hardware platform, and may be implemented by hardware, but in many cases, the former manner is a better implementation. Based on such an understanding, the technical solutions in this application essentially or the part contributing to the existing technologies may be implemented in the form of a software product. The computer software product is stored in a storage medium (for example, a read-only memory (ROM)/random access memory (RAM), a magnetic disk or an optical disc), and includes several instructions for instructing a terminal (which may be a mobile phone, a computer, a server, an air conditioner, a network device, or the like) to perform the method described in the embodiments of this application.

The embodiments of this application are described above with reference to the accompanying drawings. However, this application is not limited to the foregoing specific implementations. The foregoing specific implementations are illustrative instead of limitative. Enlightened by this application, a person of ordinary skill in the art can make many forms without departing from the idea of this application and the scope of protection of the claims. All of the forms fall within the protection of this application.

What is claimed is:

1. A method for obtaining location information, comprising:
obtaining, by a first network element, a request message, wherein the request message is used for requesting to obtain location information of an Internet of Things device, and the Internet of Things device is a device that obtains energy from an environment;
determining, by the first network element, a positioning network element based on the request message; and
receiving, by the first network element, positioning information from the positioning network element, wherein the positioning information is used for determining the location information of the Internet of Things device.

2. The method according to claim 1, wherein the request message comprises at least one of the following: identification information of the Internet of Things device, service level information, or information about a possible location of the Internet of Things device.

3. The method according to claim 2, wherein the service level information comprises at least one of the following: positioning accuracy information, positioning time information, positioning range information, or level indication information.

4. The method according to claim 1, wherein the positioning network element comprises at least one of the following: a first terminal, an access network device, a mobility management function or a location management function.

5. The method according to claim 4, wherein subscription data or capability information of the first terminal allows the first terminal to participate in positioning of the Internet of Things device.

6. The method according to claim 1, wherein the positioning information comprises at least one of the following:
identification information of a cell in which the Internet of Things device is located;
identification information of a tracking area in which the Internet of Things device is located;
geographical location information of the Internet of Things device;
relative location information of the Internet of Things device; or
a positioning reference signal measurement result of the Internet of Things device.

7. The method according to claim 1, wherein after the receiving, by the first network element, positioning information from the positioning network element, the method further comprises:
processing, by the first network element, the positioning information to obtain the location information of the Internet of Things device.

8. The method according to claim 1, wherein the positioning network element is configured to assist the first network element in obtaining the positioning information.

9. The method according to claim 1, wherein the determining, by the first network element, a positioning network element based on the request message comprises:
sending, by the first network element, a location request message to the positioning network element, wherein the location request message is used for requesting to obtain the location information of the Internet of Things device.

10. The method according to claim 1, wherein the first network element receives the request message from one of the following: a second terminal, a network exposure function.

11. The method according to claim 1, wherein
the first network element sends the location information of the Internet of Things device to the second terminal; or
subscription data of the second terminal allows the second terminal to request to obtain the location information of the Internet of Things device.

12. A method for obtaining location information, comprising:
receiving, by a positioning network element, a request message from a first network element, wherein the request message is used for requesting to obtain positioning information of an Internet of Things device, and the Internet of Things device is a device that obtains energy from an environment;
assisting, by the positioning network element based on the request message, the first network element in obtaining the positioning information, wherein the positioning information is used for determining location information of the Internet of Things device; and
sending, by the positioning network element, the positioning information to the first network element.

13. The method according to claim 12, wherein the request message comprises at least one of the following: identification information of the Internet of Things device, service level information, or information about a possible location of the Internet of Things device.

14. The method according to claim 13, wherein the service level information comprises at least one of the following: positioning accuracy information, positioning time information, positioning range information, or level indication information.

15. The method according to claim 12, wherein the positioning network element is a first terminal, wherein
subscription data or capability information of the first terminal allows the first terminal to participate in positioning of the Internet of Things device.

16. The method according to claim 12, wherein the positioning information comprises at least one of the following:
identification information of a cell in which the Internet of Things device is located;
identification information of a tracking area in which the Internet of Things device is located;
geographical location information of the Internet of Things device;
relative location information of the Internet of Things device; or
a positioning reference signal measurement result of the Internet of Things device.

17. A method for obtaining location information, comprising:
receiving, by a second network element, a request message from a second terminal, wherein the request message is used for requesting to obtain location information of an Internet of Things device, and the Internet of Things device is a device that obtains energy from an environment;
obtaining, by the second network element, the location information of the Internet of Things device; and
sending, by the second network element, the location information to the second terminal.

18. The method according to claim 17, wherein the request message comprises at least one of the following: identification information of the Internet of Things device, service level information, or information about a possible location of the Internet of Things device.

19. The method according to claim 18, wherein the service level information comprises at least one of the following: positioning accuracy information, positioning time information, positioning range information, or level indication information.

20. A terminal, wherein the terminal is a positioning network element, comprising: a memory storing instructions; and a processor coupled to the memory, wherein the instructions, when executed by the processor, cause the processor to perform the method for obtaining location information according to claim 12.

21. A network-side device, wherein the network-side device is a first network element, comprising: a memory storing instructions; and a processor coupled to the memory, wherein the instructions, when executed by the processor, cause the processor to perform the method for obtaining location information according to claim 1.
